(19) United States
(12) Patent Application Publication
(10) Pub. No.: US 2025/0277913 A1
(43) Pub. Date: Sep. 4, 2025

(54) Method for Evaluating at Least One GNSS Satellite Signal with Ambiguity Resolution

(71) Applicant: Robert Bosch GmbH, Stuttgart (DE)

(72) Inventors: Peter Zobel, Stuttgart (DE); Alexander Metzger, Rottenacker (DE); Fedor Baklanov, Muenchen (DE); Jens Strobel, Freiberg Am Neckar (DE); Mohammad Tourian, Stuttgart (DE)

(21) Appl. No.: 18/251,281

(22) PCT Filed: Nov. 2, 2021
(86) PCT No.: PCT/EP2021/080308

§ 371 Date: Sep. 11, 2023

(30) Foreign Application Priority Data
Nov. 2, 2020 (DE) 10 2020 213 769.2

(51) Int. Cl. G01S 19/39; G01S 19/44

(52) U.S. Cl. CPC G01S 19/396; G01S 19/44

(57) ABSTRACT

A method for evaluating at least one GNSS satellite signal which was received from at least one GNSS satellite in order to determine GNSS sensor data using a GNSS sensor, includes:
a) resolving an ambiguity of at least one carrier frequency of a received GNSS satellite signal using an estimation algorithm, which further determines, in addition to at least one estimation result, at least one indication of the accuracy of the estimation,
b) receiving at least one item of information, which enables, in addition to the at least one indication of the accuracy of the estimation from the estimation algorithm, a conclusion to be drawn about the accuracy of the estimation,
c) adjusting the indication of the accuracy of the estimation from the estimation algorithm using the at least one item of information determined in step b).

The invention relates to a method for evaluating at least one GNSS satellite signal, a computer program for performing the method, a machine-readable storage medium comprising the computer program, as well as a geolocation device for performing the method. The method can, for example, be applicable in the context of autonomous driving.

### PRIOR ART

Using the Global Navigation Satellite System (GNSS), it is possible to perform a geospatial position determination at any point on earth. A GNSS satellite orbits the earth and transmits encoded signals that the GNSS receiver uses to calculate the distance or separation between the receiver and the satellite by estimating the time difference between the time of signal reception and the time of transmission. For example, the estimated distances to satellites can be converted by GNSS sensors into an estimation of the location of the receiver if enough satellites are tracked (typically more than 5). Currently, there are more than 130 GNSS satellites orbiting the earth, meaning that a maximum of 65 are typically visible on the local horizon. Particularly given the emergence of the quadruple GNSS grouping, triple frequency, and/or external atmospheric constraints, by means of which, e.g., what is referred to as PPP (precise point positioning) can be provided to a user (and/or by means of ambiguity resolution), it becomes possible to contribute in an advantageous manner to achieving a precision preferably in the centimeter range using GNSS or GNSS/INS (Inertial Navigation System)-based geolocation sensors. In this context, the focus here is in particular on further improving geolocation solutions in which an ambiguity resolution is performed.

### DISCLOSURE OF THE INVENTION

Proposed here according to claim 1 is a method for evaluating at least one GNSS satellite signal which was received from at least one GNSS satellite in order to determine GNSS sensor data by means of a GNSS sensor, comprising at least the following steps:
a) resolving an ambiguity of at least one carrier frequency of a received GNSS satellite signal using an estimation algorithm, which further determines, in addition to at least one estimation result, at least one indication of the accuracy of the estimation,
b) receiving at least one item of information, which enables, in addition to the at least one indication of the accuracy of the estimation from the estimation algorithm, a conclusion to be drawn about the accuracy of the estimation,
c) adjusting the indication of the accuracy of the estimation from the estimation algorithm using the at least one item of information determined in step b).

For example, steps a), b), and c) can be performed at least once and/or repeatedly in the sequence indicated in order to perform the method. Furthermore, steps a), b), and c), in particular steps a) and b), can be performed at least partially in parallel or simultaneously.

The method can in particular be used to provide as reliable an indication as possible regarding the uncertainty of the measurement or estimation from a GNSS-based geolocation sensor. As proposed in this context, the method first adjusts the indication of the accuracy according to step c), wherein the indication of the accuracy of the estimation can be artificially deteriorated in a particularly advantageous manner in step c). For example, at least one ambiguity variance can in this case be artificially deteriorated or enhanced, particularly if the ambiguity variance is determined as a floating point number. The term “accuracy” is in this context in particular understood in terms of the “reliability” of the estimation.

For example, the GNSS sensor can be a geolocation sensor configured to perform geolocation of the GNSS sensor also based on at least GNSS measurements and/or a vehicle having the GNSS sensor. Preferably, the GNSS sensor or geolocation sensor can also be configured to perform geolocation of the GNSS sensor, and/or a vehicle having the GNSS sensor, based on GNSS measurements and inertial measurements (inertia measurements) and/or vehicle sensor data, e.g., combined or fused environmental sensor data. For example, steering angle sensors and/or wheel speed sensors can be used as vehicle sensors. For example, cameras, RADAR sensors, LIDAR sensors, and/or ultrasonic sensors can be used as environmental sensors. Furthermore, map data from a digital map and/or messages from other vehicles can be used in the geolocation process.

The at least one or each GNSS satellite signal is generally received on at least one carrier frequency. Particularly advantageously at least GNSS satellite signals provided on at least two carrier frequencies (L1, L2) can also be received.

For example, the GNSS sensor data can be an (ego) position, (ego) speed, (ego) orientation, and/or (ego) acceleration of the GNSS sensor and/or a vehicle comprising the GNSS sensor. Preferably, the GNSS sensor data include at least one (ego) position of the GNSS sensor and/or of a vehicle comprising the GNSS sensor. For example, the vehicle can be a motor vehicle, e.g. an automobile. The vehicle is preferably configured for an at least partially automated or autonomous driving operation.

In step a), a resolution of (at least) one ambiguity of at least one carrier frequency of a received GNSS satellite signal is performed using an estimation algorithm, which further determines, in addition to at least one estimation result, at least one indication of the accuracy of the estimation. For example, said particular estimation algorithm can be performed by an ambiguity filter. For example, the indication of the accuracy of the estimation can be at least one ambiguity variance and/or one ambiguity (Ko) variance matrix. Estimation algorithms used for ambiguity resolution are generally known. By way of example, a least squares adjustment can be used as an estimation algorithm.

The ambiguity resolution can optionally be performed in various modes. For example, the resolution can optionally be performed in an integer mode or in a floating point number mode. In the integer mode, the resolution can include the resolution of integer ambiguities. In the floating point number mode, the resolution can include resolving ambiguities as floating point numbers. The method is particularly applicable when the resolution is performed in said floating point number mode.

In particular, when operating in integer mode, the following can be considered: In order to achieve the highest probability for correctly resolving the integer ambiguities, the residual measurement error should be less than a quarter of a wavelength. This is often not the case and makes the integer ambiguity determination method quite complex. This is a challenging task, especially in the case of ambiguity correction in online applications, e.g., in the automotive industry. The reliability of the integer ambiguity estimation depends on several factors. First, it will depend on the strength of the underlying GNSS model determined by the measurement noise, the uncertainty of the applied corrections for troposphere and ionosphere, the satellite geometry, and the number of frequencies. Second, it depends on the integer estimation method being applied.

When operating in floating point number mode, the following can be particularly considered: In order to resolve the ambiguity, a standard least squares adjustment can be performed and the integer nature of the ambiguity disregarded. As a result, what is referred to as a float resolution of the ambiguity (or optionally of further parameters, e.g., position/baseline components and/or other potential parameters like atmospheric delays) is obtained along with an indication of the accuracy of the estimation, e.g., a variance.

For example, the (real value) float solution of ambiguities can be adjusted such that the integer constraints are considered in order to obtain an ambiguity integer solution. Several tests are used to decide whether or not to accept the integer solution. Several tests have been proposed in the literature and are currently being used in practice. Examples include the ratio test, the distance test, and the projector test. If the test fails, then the ambiguity float solution can be determined as the final solution.

Consideration can also be made of the fact that obtaining a floating point solution can typically be problematic both due to ignoring the integer nature of the ambiguity and due to the typically (compared to reality) small (and thus unrealistic) (output) ambiguity variance resulting from, e.g., the conventional least-squares method used for ambiguity resolution. The unrealistically small ambiguity variance typically results in super-optimistic carrier range variance, which in turn can result in relying predominantly on the carrier range and, e.g., scaling down the code measurements. The determination of an overly optimistic output variance can ensue, particularly the ambiguity estimation result and/or (hence also) the GNSS sensor data, thus underestimating the actual error of the signals.

In order to address the aforementioned problems given a floating point solution in particular, it is proposed here for the first time that the indication of the accuracy of the estimation from the ambiguity estimation algorithm (output variance) be adjusted artificially or subsequently in order to obtain a more realistic indication (output variance).

In step b), at least one item of information is received, which enables, in addition to the least one indication of the accuracy of the estimation from the estimation algorithm, a conclusion to be drawn about the accuracy of the estimation. The information can, e.g., be received from sensors of a vehicle, in particular in addition to the GNSS sensor. Preferably, the information can be received from a (GNSS) correction data service. In particular, the information can be received or determined from OSR correction data and/or SSR correction data, or the information can include OSR correction data and/or SSR correction data. Preferably, the information includes a correction data variance (along with the correction data) received, e.g., as provided by an external SSR or OSR server. The correction data or correction data services referred to are well known. In this context, “OSR” stands for Observation Space Representation, and “SSR” stands for State Space Representation.

In step c), the indication of the accuracy of the estimation is adjusted from the estimation algorithm using the at least one item of information determined in step b). The adjustment is in particular performed such that a (penalty) factor is applied to the (output) indication based on step a) (e.g., to an output variance) in order to obtain an (output) indication, e.g., an output variance. For example, according to the at least one item of information determined in step b), a (penalty) factor (e.g. a penalty variance) can be determined and applied to the adjustment in step c).

As a result, an embodiment example can advantageously be provided in which, particularly in the case of the use of OSR or SSR correction data and/or PPP based positioning, a penalty variance is added to the estimated ambiguity variance. This is done in particular in order to as far as possible achieve a more realistic or reliable uncertainty estimation for the output signals (ambiguity estimation and/or GNSS sensor data).

In other words, a particularly preferred embodiment example can also be described as follows: In order to avoid an overly optimistic variance for the output signals (ambiguity estimation and/or GNSS sensor data), in particular regarding the output position of GNSS/INS-based geolocation sensors (in the PPP concept), the variance of the SSR or OSR-based correction data received from an external server is used to adjust the accuracy (by OSR data).

For example, the adjustment can include multiplication by a scaling factor and/or the addition of a (penalty) factor. The (penalty) factor can in particular be determined according to information about the accuracy of (GNSS) correction data. The adjustment is performed in particular in the case of an ambiguity float solution. The result of the adjustment is in particular an output ambiguity variance.

For example, the scaling factor can be set such that, by adding the (penalty) factor (penalty variance), at least one weighting can be adjusted upon geolocation by the GNSS sensor. In particular, the scaling can be adjusted such that a weighting can be adjusted between different types of measurements, particularly including code and phase measurements.

According to one advantageous configuration, it is proposed that, in step a), the ambiguity of the carrier frequency be resolved by means of an ambiguity filter that determines a covariance matrix as an indication of the accuracy of the estimation. The ambiguity filter can, e.g., include a least squares filter. The ambiguity filter can be a component of the GNSS sensor or a geolocation device and/or connected to the latter. The ambiguity filter can be provided in addition to or integrated into a locating filter, e.g., a Kalman filter.

According to another advantageous configuration, it is proposed that the at least one item of information received in step b) include one or more of the following items of information: information from a GNSS antenna, information from an inertial sensor, information from a speed sensor, information from a GNSS correction data source. For example, a correction data service can serve as the GNSS correction data source. For example, the correction data can be received by the vehicle via an antenna (e.g., the GNSS antenna) and/or a radio connection, and/or an internet connection.

According to another advantageous configuration, it is proposed that the at least one item of information received in step b) include information from a GNSS correction data source. In particular, this information can be received or determined from (OSR and/or SSR) correction data, or it can include the information (OSR and/or SSR) correction data. In addition to the actual correction information, these correction data can also include an indication of the accuracy and/or reliability of the correction information.

According to another advantageous configuration, it is proposed that the at least one item of information received in step b) include information from a GNSS correction data source describing the accuracy and/or reliability of GNSS correction data. Preferably, this information includes an indication received (along with the correction data) on the accuracy and/or reliability of the correction data or the correction information thereof, in particular at least one correction data variance provided, e.g., by an external SSR or OSR server.

According to a further advantageous configuration, it is proposed that the at least one item of information received in step b) be provided by (at least) one sensor of a vehicle equipped with the GNSS sensor. The sensor can, e.g., be an inertial sensor and/or environmental sensor and/or (wheel) speed sensor of the vehicle.

According to a further advantageous configuration, it is proposed that, in step c), the indication of the accuracy of the estimation from the estimation algorithm be artificially degraded using the at least one item of information determined in step b). For example, a (penalty) factor can be determined using the at least one item of information determined in step b) and applied for artificial degradation.

Proposed according to a further aspect is a computer program for performing a method proposed here. In other words, this aspect relates in particular to a computer program (product) comprising instructions which, when the program is executed by a computer, prompt the latter to perform a method described here.

Proposed according to a further aspect is a machine-readable storage medium, in which the computer program proposed here is saved or stored. Conventionally, the machine-readable storage medium is a computer-readable data carrier.

Proposed according to a further aspect is a geolocation device configured to perform a method described here. The geolocation device is, in particular, a geolocation device for a vehicle. The geolocation device can, e.g., be designed to include the GNSS sensor or comprise the GNSS sensor. The geolocation means can further comprise the ambiguity filter.

The geolocation device can, e.g., comprise a computer and/or control unit (controller) able to execute instructions for performing the method. The computer or control unit can, e.g., execute the computer program specified for this purpose. For example, the computer or control unit can access the specified storage medium in order to be able to execute the computer program. For example, the geolocation device can be a movement and position sensor, in particular arranged in or on the vehicle.

The details, features, and advantageous configurations discussed in connection with the method can also occur in the computer program, and/or in the storage medium, and/or in the apparatus described here, and vice versa. In this respect, reference is made to the entirety of said explanations for a more specific characterization of the features.

The solution presented here and the technical environment thereof are explained in greater detail hereinafter with reference to the drawings. It should be noted that the invention is not intended to be limited by the embodiment examples disclosed. In particular, unless explicitly stated otherwise, it is also possible to extract partial aspects of the factual subject matter explained in the drawings and to combine them with other components and/or insights based on other drawings and/or the present description. Schematically shown are:

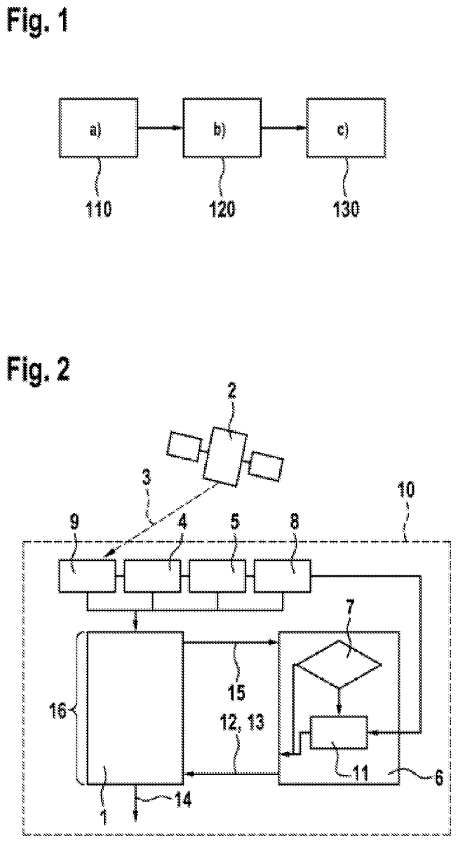

FIG. 1: an exemplary sequence of the method presented here, and

FIG. 2: an exemplary geolocation device described here.

FIG. 1 schematically shows an exemplary sequence of the method presented here. The method is used to evaluate at least one GNSS satellite signal 3 received from at least one GNSS satellite 2 to determine GNSS sensor data 14 by means of a GNSS sensor 1 (see FIG. 2). The described sequence of steps a), b), and c) shown by blocks 110, 120, and 130 is an example and can, e.g., be performed at least once in the sequence described for performing the method.

In block 110, according to step a), a resolution of an ambiguity of at least one carrier frequency of a received GNSS satellite signal 3 occurs using an estimation algorithm 7, which further determines, in addition to at least one estimation result 12, at least one indication 13 of the accuracy of the estimation. In block 120, according to step b), there is received at least one item of information 9, 4, 5, 8 that enables a conclusion to be drawn about the accuracy of the estimation from the estimation algorithm 7 in addition to the at least one indication 13. In block 130, according to step c), the indication 13 of the accuracy of the estimation from the estimation algorithm 7 is adjusted using the at least one item of information 9, 4, 5, 8 determined in step b).

FIG. 2 schematically illustrates an exemplary geolocation device 16 described here. The geolocation device 16 is arranged, e.g., in a vehicle 10 to determine, e.g., the ego position of the vehicle 10 using GNSS satellite signals 3 from GNSS satellites 2. The geolocation device 16 is configured to perform a method described here. For this purpose, the geolocation device 16 comprises, e.g., the GNSS sensor 1 and an ambiguity filter 6. The ego position is in this case one example of GNSS sensor data 14.

The ambiguity filter 6 can obtain data 15 from the GNSS sensor 16, which data (still) exhibit ambiguity due to the ambiguity of the carrier frequency. The ambiguity of the carrier frequency can be resolved by means of the ambiguity filter 6. The ambiguity filter 6 can include an estimation algorithm 7 for this purpose. The estimation algorithm 7 can optionally output an integer solution (arrow at bottom left) or a floating point solution (downward vertical arrow). The solution includes both the estimation result 12 and the indication 13 of the accuracy of the estimation, which can be communicated (collectively) to the GNSS sensor 16. For example, at least one variance and/or one covariance matrix can be determined as an indication 13 of the accuracy of the estimation.

The indication 13 can include, e.g., a carrier range variance (mathematical symbol: σ_C), which is the sum of measurement variance (mathematical symbol: σ_Cmeas) and an estimation variance (mathematical symbol: σ_Cest):

$${σ}_{C}^{2} = {σ}_{Cmeas}^{2} + {σ}_{Cest}^{2}$$

The measurement variance of the carrier ranges is in this case generally dependent on the carrier phase measurement variance (mathematical symbol: σ_phase) plus the ambiguity variance (mathematical symbol: σ_amb):

$${σ}_{Cmeas}^{2} = {σ}_{phase}^{2} + {σ}_{amb}^{2}$$

In particular, when a floating point solution (downward vertical arrow) is output, the indication 13 is adjusted in, e.g., an adder 11. A penalty variance (mathematical symbol: σ_pen) can be summed for this purpose:

$${σ}_{Cmeas}^{2} = {σ}_{phase}^{2} + {σ}_{amb}^{2} + {σ}_{pen}^{2}$$

This represents an example of the fact that the indication 13 of the accuracy of the estimation from the estimation algorithm 7 can be artificially degraded, as optionally performed in step c). This is advantageously performed using the at least one item of information 9, 4, 5, 8 determined in step b).

The at least one item of information 9, 4, 5, 8 received in step b) can include one or more of the following items of information: information from a GNSS antenna 9, information from an inertial sensor 4, information from a speed sensor 5, information from a GNSS correction data source 8.

Preferably, the at least one item of information 9, 4, 5, 8 includes information from a GNSS correction data source 8. Particularly preferably, the at least one item of information 9, 4, 5, 8 includes information from a GNSS correction data source 8 describing the accuracy and/or reliability of GNSS correction data.

Furthermore, preferably, the information received from the GNSS correction data source 8 includes an indication (along with the correction data) of the accuracy and/or reliability of the correction data or its correction information, in particular at least one correction data variance provided, e.g., by an external SSR or OSR server.

Based on the information from the GNSS correction data source 8, a penalty variance can be determined and applied to the indication 13 in the adder 11. The penalty variance can in this case be generated, e.g., based on the SSR or OSR line of sight correction variance multiplied by a scaling factor.

Alternatively, or cumulatively, the at least one item of information 9, 4, 5, 8 can be provided by a sensor of a vehicle 10 equipped with the GNSS sensor 1. In particular, the GNSS antenna 9, the inertial sensor 4, and/or the speed sensor 5 can in this context come into consideration as sensors of the vehicle 10.

As a result, a particularly advantageous approach to obtaining a more realistic uncertainty for the estimated position based on a (GNSS/INS-based) geolocation sensor can be provided with respect to a solution for the carrier phase ambiguity.

In particular, adding a penalty variance can contribute to the estimated ambiguity variance. The penalty variance can be determined or calculated using received correction data (SSR or OSR).

For example, the total of the variance of the ionosphere, troposphere, orbital, clock, and phase distortion corrections can be multiplied by a scaling factor in order to calculate the penalty variance.

The scaling factor can, e.g., be set such that, by adding the penalty variance, at least one weighting can be adjusted upon geolocation by the GNSS sensor 1. In particular, the scaling can be adjusted such that a weighting can be adjusted between various types of measurement, particularly including code and phase measurements.

1. A method for evaluating at least one GNSS satellite signal which was received from at least one GNSS satellite in order to determine GNSS sensor data using a GNSS sensor, comprising:
a) resolving an ambiguity of at least one carrier frequency of a received GNSS satellite signal using an estimation algorithm, which further determines, in addition to at least one estimation result, at least one indication of the accuracy of the estimation,
b) receiving at least one item of information, which enables, in addition to the at least one indication of the accuracy of the estimation from the estimation algorithm a conclusion to be drawn about the accuracy of the estimation, and
c) adjusting the indication of the accuracy of the estimation from the estimation algorithm using the at least one item of information determined in step b).

2. The method according to claim 1, wherein, in step a), the ambiguity of the at least one carrier frequency is resolved using an ambiguity filter, which determines a covariance matrix as an indication of the accuracy of the estimation.

3. The method according to claim 1, wherein the at least one item of information received in step b) includes one or more of the following items of information:
information from a GNSS antenna;
information from an inertial sensor;
information from a speed sensor; and
information from a GNSS correction data source.

4. The method according to claim 1, wherein the at least one item of information received in step b) includes information from a GNSS correction data source.

5. The method according to claim 1, wherein the at least one item of information received in step b) includes information from a GNSS correction data source describing an accuracy and/or reliability of GNSS correction data.

6. The method according to claim 1, wherein the at least one item of information received in step b) is provided by a sensor of a vehicle equipped with the GNSS sensor.

7. The method according to claim 1, wherein, in step c), the indication of the accuracy of the estimation is artificially degraded based on the estimation algorithm using the at least one item of information determined in step b).

8. A computer program configured to perform method according to claim 1 when executed by a controller.

9. A non-transitory machine-readable storage medium on which the computer program according to claim 8 is stored.

10. A geolocation device configured to perform the method according to claim 1.
